(19) United States
(12) Patent Application Publication
(10) Pub. No.: US 2013/0148071 A1
(43) Pub. Date: Jun. 13, 2013

(54) VERTICAL ALIGNMENT LIQUID CRYSTAL DISPLAY

(71) Applicants: Innocom Technology (Shenzhen) Co., Ltd., Shenzhen City (CN); Chimei Innolux Corporation, Chu-Nan (TW)

(72) Inventors: Ying-Jen CHEN, Chu-Nan (TW); Yi-Da HUANG, Chu-Nan (TW); Wei-Jean LIU, Chu-Nan (TW); Chih-Yung HSIEH, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/710,311

(22) Filed: Dec. 10, 2012

(30) Foreign Application Priority Data
Dec. 13, 2011 (TW) 100145893

(51) Int. Cl. G02F 1/1343

(52) U.S. Cl. CPC G02F 1/134336
USPC 349/143

(57) ABSTRACT

The invention provides a vertical alignment liquid crystal display, including: a first substrate; a plurality of data lines formed on the first substrate; a plurality of gate lines formed on the first substrate, wherein the gate lines intersect the data lines to define a plurality of the pixel regions; a plurality of common electrodes formed on the first substrate, wherein the common electrodes are located on a border of the pixel regions and next to the gate lines; a second substrate oppositely disposed to the first substrate; and a liquid crystal layer formed between the first substrate and the second substrate, wherein the liquid crystal layer includes a plurality of optically active materials.

### CROSS REFERENCE TO RELATED APPLICATIONS

This Application claims priority of Taiwan Patent Application No. 100145893, filed on Dec. 13, 2011, the entirety of which is incorporated by reference herein.

### BACKGROUND

1. Field of the Disclosure

The present disclosure relates to a liquid crystal display, and in particular relates to a vertical alignment liquid crystal display.

2. Description of the Related Art

Liquid crystal displays (LCD) are widely used in personal computers, personal digital assistants (PDA), mobile phones or TVs, because they are light, have low power consumption and no radiation.

The liquid crystal display includes a thin film transistor (TFT) substrate and a color filter (CF) substrate facing each other with a liquid crystal layer interposed therebetween.

The conventional twisted nematic (TN) device has good transmittance performance. However, the conventional TN device has a very narrow viewing-angle. Therefore, a vertical alignment (VA) type wide-viewing-angle LCD has been developed to solve the aforementioned problems. The VA type LCD comprises a patterned vertical alignment (PVA) type LCD, a multi-domain vertical alignment (MVA) type LCD, and etc. The PVA type LCD achieves the goal of wide-viewing-angle characteristics by applying a fringing-field effect thereto and optical compensation films. The MVA type LCD widens the viewing-angle and improves transmittance of the liquid crystal display by dividing a pixel area into multi domains and tilting liquid crystals respectively in the multi domains in several different directions using protrusion features or specific patterns.

The conventional common electrodes are disposed in the pixel regions (displaying regions). However, as the resolution of LCD increases, if the common electrode is still designed in the pixel region, the aperture ratio (AR) of LCD will therefore be reduced. Therefore, there is a need to develop a vertical alignment liquid crystal display to resolve the above-mentioned problem.

### BRIEF SUMMARY

The invention provides a vertical alignment liquid crystal display, comprising: a first substrate; a plurality of data lines formed on the first substrate; a plurality of gate lines formed on the first substrate, wherein the gate lines intersect the data lines to define a plurality of the pixel regions; a plurality of common electrodes formed on the first substrate, wherein the common electrodes are located on a border of the pixel regions and next to the gate lines; a second substrate oppositely disposed to the first substrate; and a liquid crystal layer formed between the first substrate and the second substrate, wherein the liquid crystal layer comprises a plurality of optically active materials.

A detailed description is given in the following embodiments with reference to the accompanying drawings.

### BRIEF DESCRIPTION OF THE DRAWING

For a more complete understanding of the present disclosure, and the advantages thereof, reference is now made to the following descriptions taken in conjunction with the accompanying drawings, in which:

FIG. 1 shows a cross-sectional schematic representation of a display region of the vertical alignment crystal liquid display of the invention;

FIGS. 2a-2b show the side views of showing one exemplary embodiment of liquid crystal molecules of the liquid crystal layer of the vertical alignment liquid crystal display device of the invention;

FIG. 2c shows a transmittance diagram showing a liquid crystal display device formed by a liquid crystal material without the chiral dopants;

FIG. 2d shows a transmittance diagram showing a liquid crystal display device formed by a liquid crystal material with the chiral dopants.

FIG. 3a shows a top-view schematic representation of the first substrate of the invention;

FIG. 3b shows a cross-sectional schematic representation taken along AA′ line on FIG. 3a;

FIG. 3c-3d show the cross-sectional schematic representation of the common electrode of the invention;

FIGS. 4a to 4c show transmittance-voltage curve diagrams corresponding to different parameters of the liquid crystal rotations (d/p ratio) of a vertical alignment type liquid crystal display at zero-degree, 45-degree and 90-degree viewing-angles;

FIG. 5 shows a transmittance-voltage curve diagram showing the definition of the gray-level inversion;

FIG. 6 shows transmittance distribution diagram corresponding to different parameters of the optical path difference (Δnd) and liquid crystal rotations (d/p ratio) of one exemplary embodiment of a liquid crystal display device of the invention, which comprises a liquid crystal layer with the chiral dopants, at a zero-degree viewing-angle; and

FIGS. 7a and 7b show gray-level inversion value distribution diagrams corresponding to different parameters of the optical phase retardation factor R and liquid crystal rotations (d/p ratio) of one exemplary embodiment of a vertical alignment liquid crystal display of the invention, which comprises a liquid crystal layer with the chiral dopants, at 45-degree and 90-degree viewing-angles, respectively.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

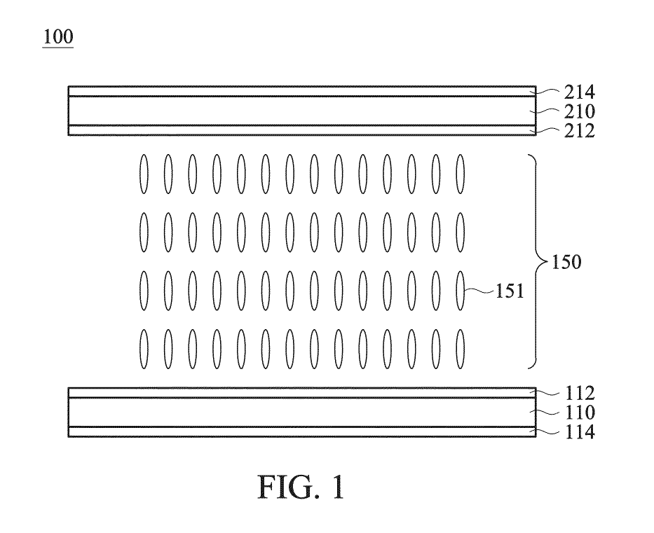

FIG. 1 shows a cross-sectional schematic representation of a displaying region of a vertical alignment crystal liquid display 100. The vertical alignment crystal liquid display 100 comprises a first substrate 110 and a second substrate 210, and a liquid crystal layer 150 is formed between the first substrate 110 and the second substrate 210, wherein the first substrate 110 and the second substrate 210 are disposed oppositely to each other, and the liquid crystal layer 150 comprises the liquid crystal molecules 151 and an optically active material which comprises a plurality of chiral dopants.

Additionally, a pixel electrode 112 is formed on the first substrate 110, and a first polarizer 114 is formed below the first substrate 110. A counter electrode 212 is formed below the second electrode 210, and a second polarizer 214 is formed on the second substrate 210. The pixel electrode 112 and the counter electrode 212 are formed by transparent conducting materials, such as indium tin oxide (ITO). A capacity (CO of the vertical alignment liquid crystal display 100 is made by the pixel electrode 112 and the counter electrode 212.

In another embodiment, the vertical alignment liquid crystal display 100 further comprises a first compensation film (not shown in figure) disposed between the first substrate 110 and the first polarizer 114, and a second compensation film (not shown in figure) disposed between the second substrate 210 and the second polarizer 214.

The color filters and black matrix (not shown in figure) are disposed between the second substrate 210 and the liquid crystal layer 150. The color filters comprise red color filters, blue color filters and green color filters, and the black matrix is disposed between the two color filters with different colors.

In one embodiment, the liquid crystal molecules 151 of the liquid crystal layer 150 comprise a nematic liquid crystal material, for example, a negative nematic liquid crystal or a positive nematic liquid crystal. The first substrate 110 is a thin film transistor substrate and the second substrate 210 is a color filter substrate.

The chiral dopants are added in the liquid crystal layer 150, thus the liquid crystal molecules 151 of the liquid crystal layer 150 may twist along an axis direction, thereby having optical activity, and the axis direction is parallel to a normal line of the first substrate 110. The twist angle of the liquid crystal molecules 151 can be defined by controlling the concentration of the chiral dopants. Therefore, the vertical alignment liquid crystal display 100 of the invention is also named as “twisted vertical alignment liquid crystal display”.

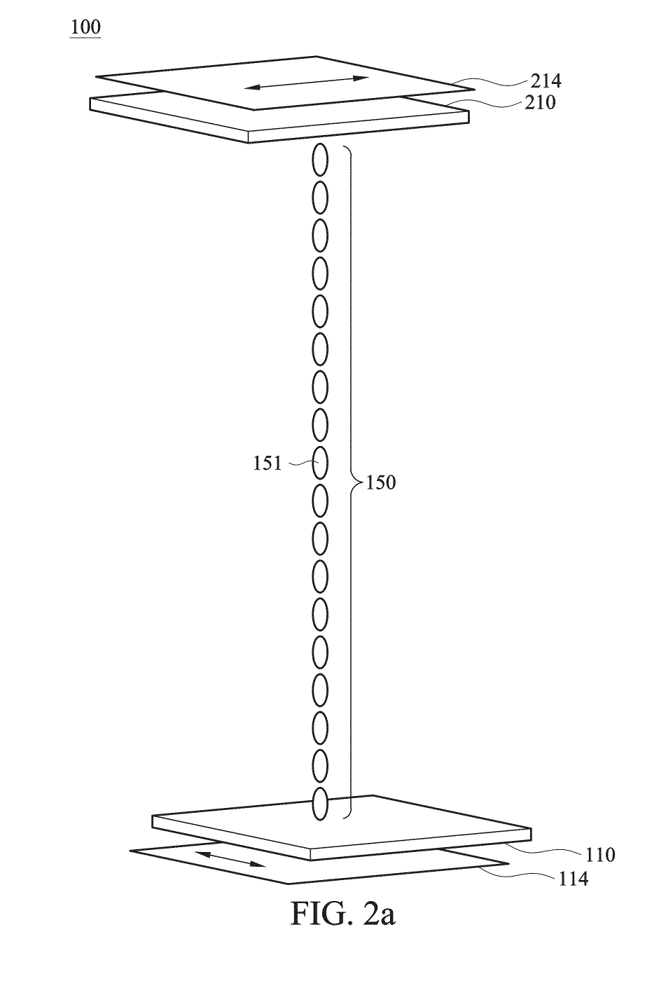

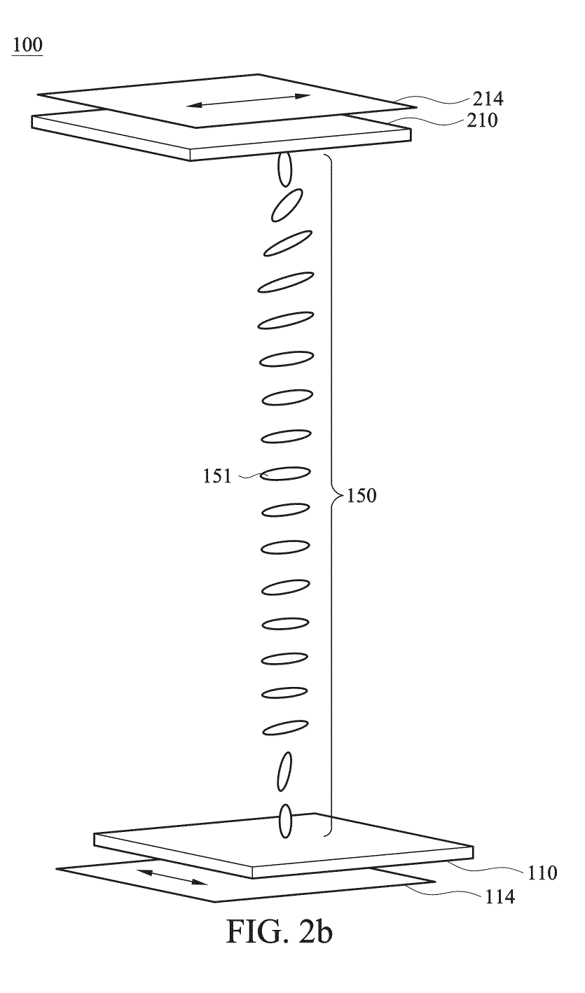

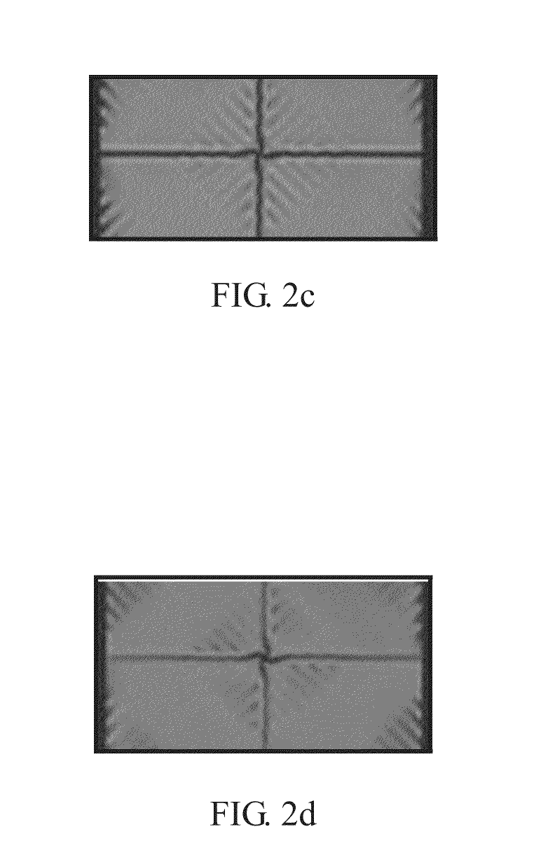

FIG. 2a is a side view of showing one exemplary embodiment of liquid crystal molecules 151 of the liquid crystal layer 150 of the vertical alignment liquid crystal display device 100 of the invention without an electronic field applied between the first substrate 110 and the second substrate 210. Directions of arrows on the first polarizer 114 and the second polarizer 214 illustrate directions of the polarization axis of the first substrate 110 and the second substrate 210, respectively.

FIG. 2b is a side view of showing one exemplary embodiment of liquid crystal molecules 151 of the liquid crystal layer 150 of the vertical alignment liquid crystal display device 100 of the invention with an electronic field applied between the first substrate 110 and the second substrate 210. As shown in FIG. 2b, the liquid crystal molecules 151 are gradually twisted from the first substrate 110 to the second substrate 210, and the liquid crystal molecules 151 are gradually tilted to be arranged along a horizontal direction and then the liquid crystal molecules 151 are tilted from the horizontal direction to along a vertical direction. Along with increasing the applied electronic field, a range of the liquid crystal molecules 151 tilted to be horizontally arranged is increased. The twist angle of the liquid crystal molecules 151 can be defined by controlling the concentration of the chiral dopants.

Please refer to FIGS. 2c and 2d. FIG. 2c is a transmittance diagram showing a liquid crystal display device formed by a liquid crystal material without the chiral dopants. FIG. 2d is a transmittance diagram showing one exemplary embodiment of a liquid crystal display device formed by a liquid crystal material with the chiral dopants. As shown in FIGS. 2c and 2d, because the liquid crystal molecules with the chiral dopants can result in a macroscopic helical twist, the optical dark lines, which result from the non-tilting or tilting error problems of the liquid crystal molecules, in the display area of the liquid crystal display device as shown in FIG. 2c, are thinner and lighter than the optical dark lines as shown in FIG. 2d. Therefore, the liquid crystal display device has high-transmittance characteristics.

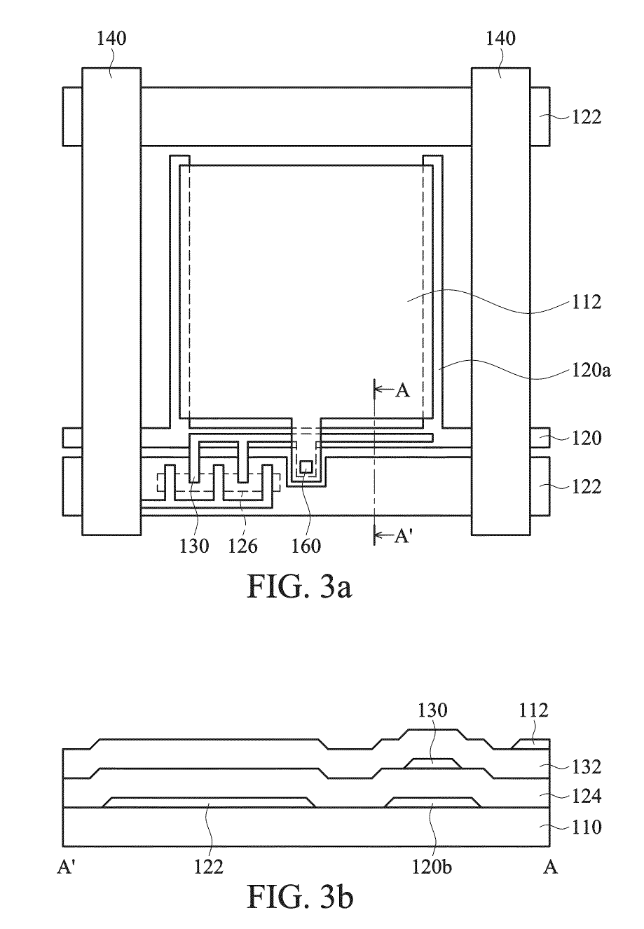

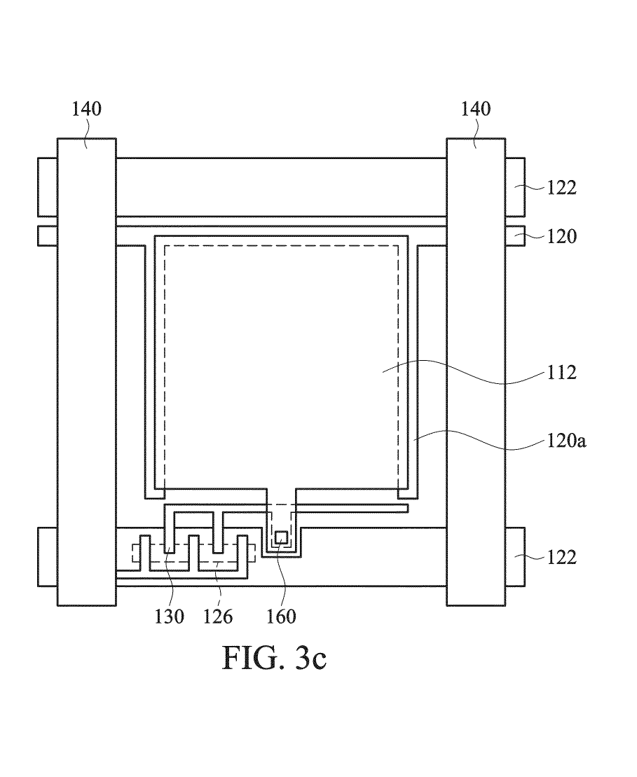

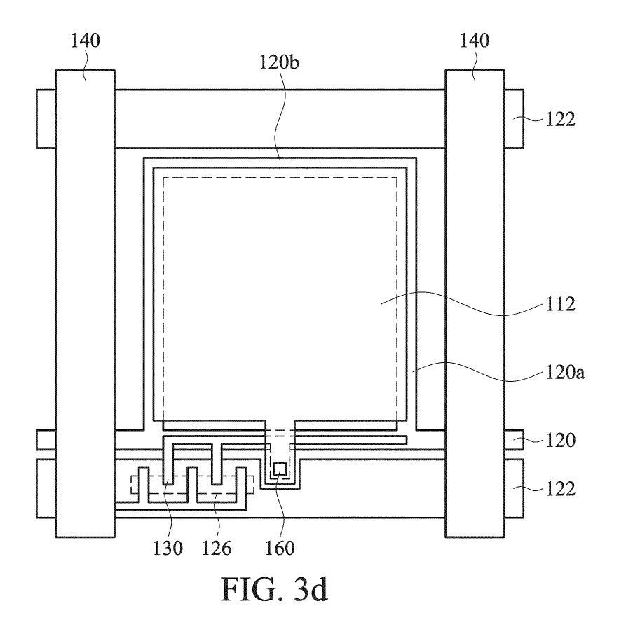

FIG. 3a shows a top-view schematic representation of the first substrate 110 of the invention. The common electrodes 120, the gate lines 122 and the data lines 140 are formed on the first substrate 110, and the gate lines 122 intersect the data lines 140 to define a plurality of the pixel regions. The pixel regions are formed by the pixel electrode 112 (see FIG. 1). Thus, the pixel regions are also called as displaying regions.

In one embodiment, the common electrodes 120 are formed on the first substrate 110 and are located on a border of the pixel regions and next to the gate lines 122. The common electrodes 120 further comprises a first extending electrode 120a which is parallel to the data lines 140 and formed on the border of the pixel regions. A “U-like” shape on the border of the pixel regions is constructed by the common electrodes 120 and the first extending electrode 120a. In a preferred embodiment, a distance between the common electrodes 120 and the gate lines 122 is smaller than about 15 μm.

Referring to FIG. 3c, in another embodiment, an “inverted U-like” shape on the border of the pixel regions is constructed by the common electrodes 120 and the first extending electrode 120a.

Referring FIG. 3d, in yet another embodiment, the common electrodes 120 comprises a first extending electrode 120a and a second extending electrode 120b, wherein the first extending electrode 120a is parallel to the data lines 140, and the second extending electrode 120b is parallel to the gate lines 122 and formed on the border of the pixel regions.

In another embodiment, the common electrodes 120 and the gate lines 122 both may be disposed in the same layer. The common electrodes 120 formed on the border of the pixel regions entirely overlap or partially overlap the gate lines 122. Furthermore, the common electrodes 120 further comprises a extending electrode 120a which is parallel to the data lines 140 and formed on the border of the pixel regions.

Note that because the chiral dopants are added into the liquid crystal layer 150 and the common electrodes 120 are disposed in the pixel region close to a horizontal side of the gate lines 122, the transmittance performance of the pixel regions and the aperture ratio (AR) of vertical alignment liquid crystal display are improved.

Moreover, a semiconductor layer 126 is formed on the common electrodes 120, and a second metal layer 130 is formed on the semiconductor layer 126. A thin film transistor is constructed by the gate lines 122, a first insulting material 124, the semiconductor layer 126 and the second metal layer 130. The second metal layer 130 is electrically connected to the date lines 140.

Additionally, the pixel electrode 112 is electrically connected to the second metal layer 130 by a contact hole 160 to transfer a signal to the thin film transistor.

FIG. 3b shows a cross-sectional schematic representation taken along AA′ line on FIG. 3a. The common electrodes 120 and the gate lines 122 are firstly formed on the first substrate 110 and formed in the same layer by a single process.

A metal layer is firstly formed on the first substrate 110 and then a patterned process is performed to the metal layer to form the common electrodes 120 and the gate lines 122, and the common electrodes 120 and the gate lines 122 respectively have different functions.

The patterned process is a photolithography process which comprises photoresist coating, soft baking, mask aligning, exposure, post-exposure, developing photoresist and hard baking. These processes are known to those skilled in the art, and thus are omitted for clarity.

Then, the first insulating layer 124 is formed on the common electrodes 120 and the gate lines 122. The first insulating layer 124 comprises silicon oxide, silicon nitride or silicon oxynitride, etc.

Next, the second metal layer 130 is formed on the first insulting layer 124, and the second insulating layer 132 is formed on the second metal layer 130. The material of the second insulating layer 132 may be the same or different with that of the first insulating material 124.

Note that the second metal layer 130 and the data lines 140 (shown in FIG. 3a) are formed by a single process and are electrically connected to each other. A signal of the thin film transistor is transferred to an external portion by the data lines.

Furthermore, a storage capacitor (Cₛₜ) is constructed by the second metal layer 130, the common electrodes 120 and the first insulating layer 124 therebetween.

Then, the pixel electrode 112 is formed on the second insulating layer 132. The material of the pixel electrode 112 is a transparent conducting material, such as indium tin oxide (ITO), indium zinc oxide (IZO), cadmium tin oxide (CTO), aluminum zinc oxide (AZO), indium tin zinc oxide (ITZO), zinc oxide, cadmium oxide (CdO) or hafnium oxide (HfO).

In another embodiment, the common electrode 120 and the gate lines 122 are disposed in different layers. The common electrode 120 and the second metal layer 130 may be disposed in the same layer. Alternatively, the common electrode 120 and the pixel electrode 112 may be disposed in the same layer. The common electrodes 120 are disposed on the gate lines 122 and entirely overlap or partially overlap the gate lines 122.

Compared with prior art, the common electrodes 120 of the invention are disposed in the pixel region close to a side of the gate lines 122. Thus, the transmittance performance and displaying performance of the vertical alignment liquid crystal display are improved.

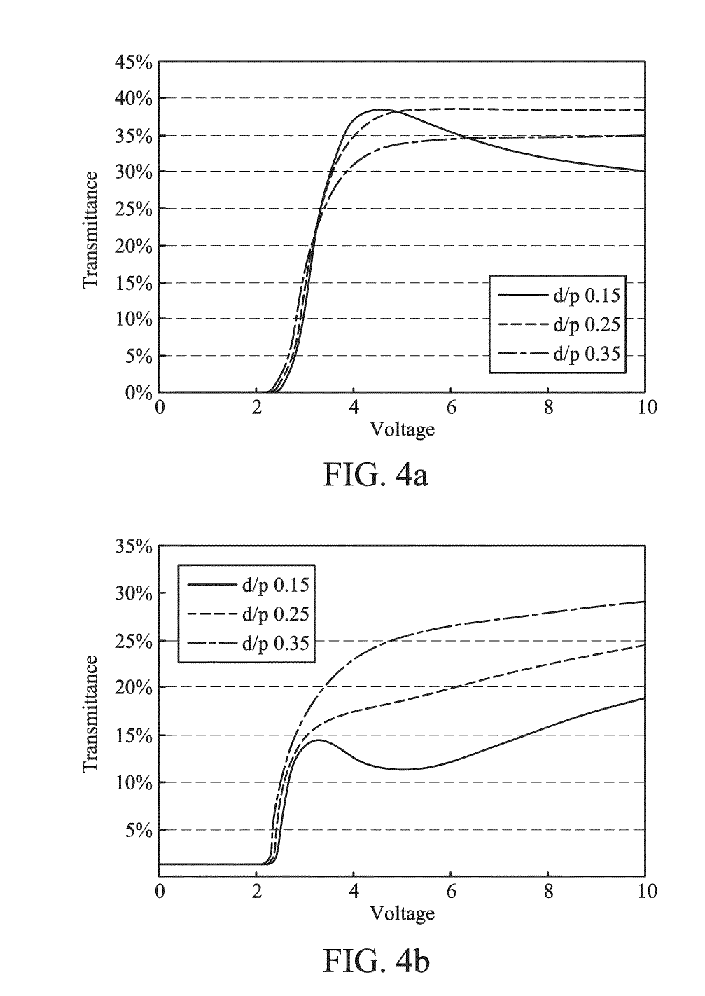

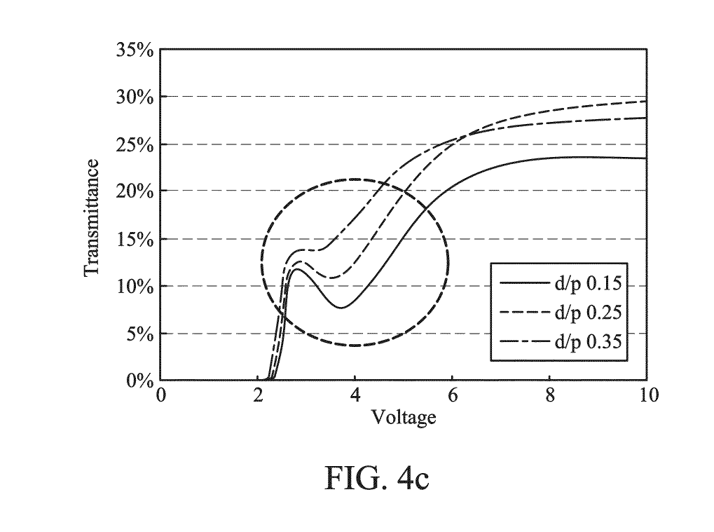

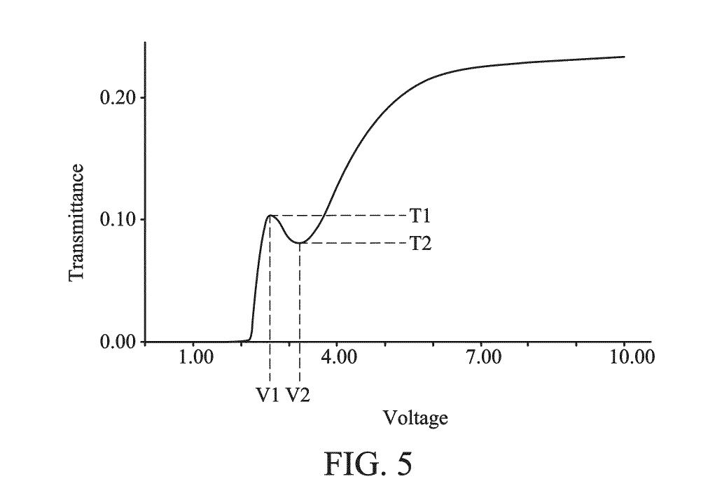

Please refer to FIGS. 4a to 4c and FIG. 5. FIGS. 4a to 4c are transmittance-voltage curve diagrams corresponding to different parameters of the liquid crystal rotations (d/p ratio) of a vertical alignment type liquid crystal display, which comprises a liquid crystal layer with the chiral dopants, at a zero-degree viewing-angle (vertical viewing-angle), a 45-degree viewing-angle and a 90-degree viewing-angle (horizontal viewing-angle), wherein d is a thickness of the liquid crystal layer with the chiral dopants, P is a pitch of the chiral dopants, Δn is a birefringence coefficient of the liquid crystal layer with the chiral dopants (also referred to as refractive index differences between the fast axis and slow axis of the liquid crystal layer with the chiral dopants). FIG. 5 shows a transmittance-voltage curve diagram to explain the definition of the gray-level inversion (also referred to as delta T). The corresponding transmittance decreases when the voltage increases (for example, from V1 to V2), and the gray-level inversion occurs (in other words, when the transmittance T1 corresponding to the voltage V1 minus the transmittance T2 corresponding to the voltage V2 is larger than zero (delta T=T1−T2>0), the gray-level inversion occurs). As shown in FIG. 4a, the parameter of the liquid crystal rotations (d/p ratio) is as small as 0.15, and the corresponding transmittance decreases when the voltage increases. As shown in FIG. 4b, the gray-level inversion occurs when the VA type liquid crystal display has a small parameter of the liquid crystal rotations (d/p=0.15) at a 45-degree viewing-angle. As shown in FIG. 4c, the gray-level inversion becomes worse when the VA type liquid crystal display is at the horizontal viewing-angle. The gray-level inversion occurs when the parameters of the liquid crystal rotations (d/p ratio) are 0.15, 0.25 and 0.35.

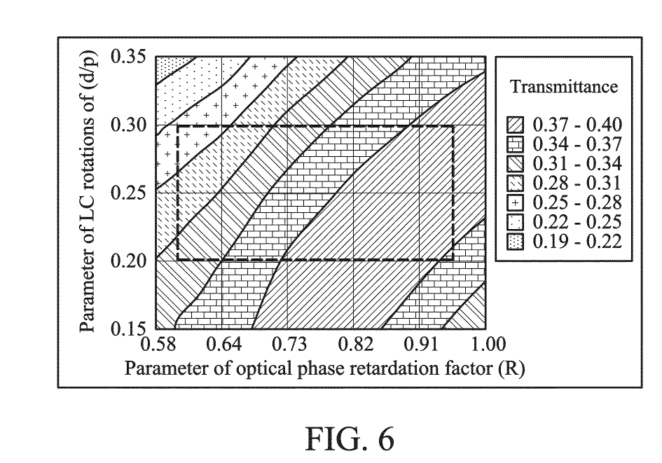

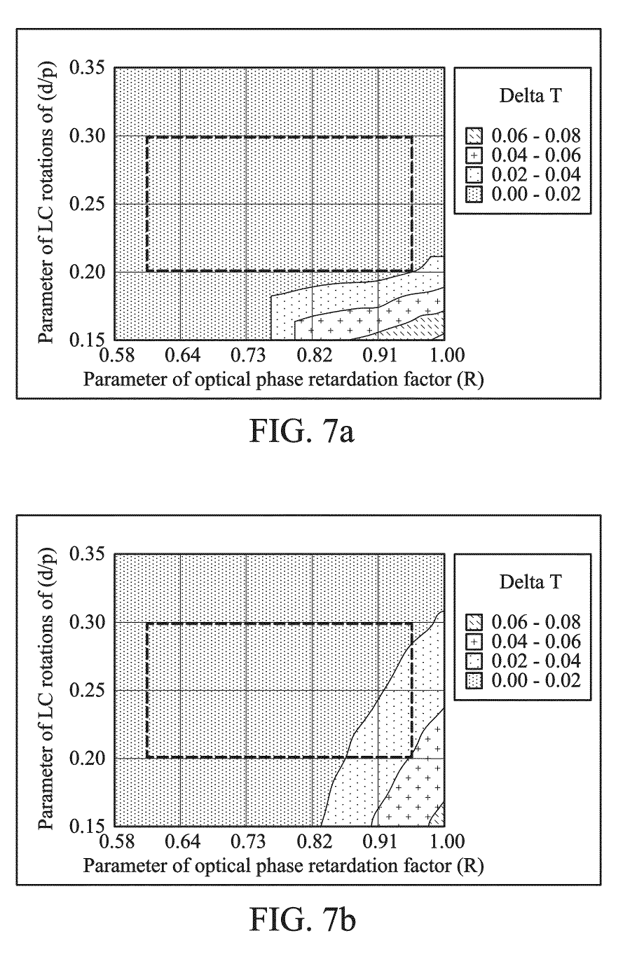

In order to find the preferred parameters of the optical phase retardation factor R, liquid crystal rotations (d/p ratio) and optical path difference (Δnd) of a vertical alignment liquid crystal display, which comprises a liquid crystal layer with the chiral dopants, to improve the transmittance of the liquid crystal display device without gray-level inversion, the numerical simulation method is used to analyze and calculate the transmittance distribution corresponding to different parameters of the optical path difference (Δnd) and liquid crystal rotations (d/p ratio) of a display region of a liquid crystal display device, which comprises a liquid crystal layer with the chiral dopants. When an incident light penetrates a liquid crystal layer having the birefringence characteristic, a parameter of the optical phase retardation factor R is represented as

$$\frac{Δ nd}{λ} ,$$

wherein λ is a wavelength of an incident light. FIG. 6 shows transmittance distribution diagram corresponding to different parameters of the optical path difference (Δnd) and liquid crystal rotations (d/p ratio) of one exemplary embodiment of the vertical alignment liquid crystal display device 100 of the invention, which comprises a liquid crystal layer with the chiral dopants, at a zero-degree viewing-angle. In this embodiment, the vertical alignment liquid crystal display device 100 is operated by an incident light having a wavelength between 380 nm and 780 nm. FIGS. 7a and 7b show gray-level inversion (delta T) value distribution diagrams corresponding to different parameters of the optical phase retardation factor R and liquid crystal rotations (d/p ratio) of one exemplary embodiment of a vertical alignment liquid crystal display device 100 of the invention, which comprises a liquid crystal layer with the chiral dopants, at 45-degree and 90-degree viewing-angles, respectively.

Please refer to FIGS. 6, 7a and 7b. In one embodiment, the parameters of the liquid crystal rotations (d/p ratio) and optical phase retardation factor R of the liquid crystal layer with the chiral dopants of the liquid crystal display device 100 respectively satisfy Equation (1) and Equation (2) (corresponding to a region surrounded by a dotted line of FIG. 6). When the parameters of the liquid crystal rotations (d/p ratio) and optical phase retardation factor R of the liquid crystal layer with the chiral dopants of the liquid crystal display device 100 preferably respectively satisfy Equation (1) and Equation (2), the transmittance values of the vertical alignment liquid crystal display device 100 is between 0.25 and 0.4. Also, the gray-level inversion (delta T) value of the vertical alignment liquid crystal display device 100 at a 45-degree viewing-angle is not larger than 0.02 (corresponding to a region surrounded by a dotted line of FIG. 7a). Further, the gray-level inversion (delta T) value of the liquid crystal display device 100 at a 90-degree viewing-angle is not larger than 0.04 (corresponding to a region surrounded by a dotted line of FIG. 7b).

0.6<R<0.95 Equation (1)

0.2≦d/p≦0.3 Equation (2)

When the parameter of the optical phase retardation factor R of the liquid crystal layer with the chiral dopants of the liquid crystal display device 100, which is operated by an incident light having a wavelength between 380 nm and 780 nm, satisfies Equation (1), the value of the optical path difference (Δnd) is between 228 nm and 741 nm. In one embodiment, the parameter of the optical path difference (Δnd) of the vertical alignment liquid crystal display device 100, which comprises a liquid crystal layer with the chiral dopants, may preferably satisfy Equation (3). When the parameters of the liquid crystal rotations (d/p ratio) and optical path difference (Δnd) of the liquid crystal display device 100, which comprises the liquid crystal layer 150 with the chiral dopants, preferably respectively satisfy Equation (2) and Equation (3), the gray-level inversion (delta T) value of the vertical alignment liquid crystal display device 100 at a 45-degree viewing-angle is not larger than 0.02 (corresponding to a region surrounded by a dotted line of FIG. 7a). Further, the gray-level inversion (delta T) value of the vertical alignment liquid crystal display device 100 at a 90-degree viewing-angle is not larger than 0.04 (corresponding to a region surrounded by a dotted line of FIG. 7b).

330<Δnd<500 Equation (3)

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vertical alignment liquid crystal display, comprising:
a first substrate;
a plurality of data lines formed on the first substrate;
a plurality of gate lines formed on the first substrate, wherein the gate lines intersect the data lines to define a plurality of pixel regions;
a plurality of common electrodes formed on the first substrate, wherein the common electrodes are located on a border of the pixel regions and next to the gate lines;
a second substrate oppositely disposed to the first substrate; and
a liquid crystal layer formed between the first substrate and the second substrate, wherein the liquid crystal layer comprises a plurality of optically active materials.

2. The vertical alignment liquid crystal display as claimed in claim 1, further comprising:
a first polarizer formed below the first substrate; and
a second polarizer formed on the second substrate.

3. The vertical alignment liquid crystal display as claimed in claim 1, wherein a distance between the common electrodes and the gate lines is smaller than about 15 μm.

4. The vertical alignment liquid crystal display as claimed in claim 1, wherein the common electrodes entirely overlap or partially overlap the gate lines.

5. The vertical alignment liquid crystal display as claimed in claim 1, wherein the common electrodes further comprise a first extending electrode, and the first regions.

6. The vertical alignment liquid crystal display as claimed in claim 5, wherein the common electrodes further comprise a second extending electrode, and the second extending electrode is parallel to the gate lines and located on the border of the pixel regions.

7. The vertical alignment liquid crystal display as claimed in claim 6, wherein the second extending electrode connected to the first extending electrode.

8. The vertical alignment liquid crystal display as claimed in claim 1, wherein a parameter of the liquid crystal rotations (d/p ratio) of the liquid crystal layer is between 0.2 and 0.3, d is a thickness of the liquid crystal layer, and p is a pitch of the optically active materials.

9. The vertical alignment liquid crystal display as claimed in claim 1, wherein a parameter of the optical path difference (Δnd) of the liquid crystal layer is larger than 330 and less than 600, Δn is a birefringence coefficient of the liquid crystal layer, and d is a thickness of the liquid crystal layer.

10. The vertical alignment liquid crystal display as claimed in claim 1, wherein a parameter of the optical path difference (Δnd) of the liquid crystal layer is larger than 330 and less than 500, Δn is a birefringence coefficient of the liquid crystal layer, and d is a thickness of the liquid crystal layer.

11. The vertical alignment liquid crystal display as claimed in claim 1, wherein a parameter of the optical phase retardation factor (R) of the liquid crystal layer is larger than 0.6 and less than 1.1.

12. The vertical alignment liquid crystal display as claimed in claim 1, wherein a parameter of the optical phase retardation factor (R) of the liquid crystal layer is larger than 0.6 and less than 0.95.

13. The vertical alignment liquid crystal display as claimed in claim 1, wherein the first substrate is a thin film transistor substrate, and the second substrate is a color filter substrate.

14. The vertical alignment liquid crystal display as claimed in claim 1, wherein the liquid crystal layer comprises a nematic liquid crystal material.

15. The vertical alignment liquid crystal display as claimed in claim 1, further comprising a color filter and a counter electrode formed on the second substrate.

16. The vertical alignment liquid crystal display as claimed in claim 1, wherein the optically active materials comprise chiral dopants.
